(19) United States
(12) Patent Application Publication
(10) Pub. No.: US 2017/0239814 A1
(43) Pub. Date: Aug. 24, 2017

(54) PROCESSING TIME PREDICTION METHOD

(71) Applicant: HONDA MOTOR CO., LTD., Minato-ku (JP)

(72) Inventors: Wataru TOYAMA, HAGAGUN (JP); Masahiro YAMANAKA, HAGAGUN (JP); Shunya SUGURO, HAGAGUN (JP)

(21) Appl. No.: 15/437,974

(22) Filed: Feb. 21, 2017

(30) Foreign Application Priority Data
Feb. 24, 2016 (JP) 2016-032859

(51) Int. Cl. B25J 9/16; B25J 13/08; G04F 10/00

(52) U.S. Cl. CPC B25J 9/1664; G04F 10/00; B25J 13/088

(57) ABSTRACT

A processing time prediction method includes the following steps. A plurality of sampling points are set, defined by segmenting an operation time period into respective sampling time intervals. A posture assumed by a first robot and a posture assumed by a second robot for each of the sampling points are calculated, and a posture calculation time is measured. The posture assumed by the first robot and the posture assumed by the second robot for each of the sampling points are calculated, the presence or absence of interference is detected, and a posture calculation and interference detection time is measured. An interference detection time at the plurality of sampling points is computed, from a difference between the posture calculation and interference detection time and the posture calculation time. A unit processing time is computed by dividing the interference detection time by a number of the set sampling points.

### CROSS-REFERENCE TO RELATED APPLICATION

This application is based upon and claims the benefit of priority from Japanese Patent Application No. 2016-032859 filed on Feb. 24, 2016, the contents of which are incorporated herein by reference.

### BACKGROUND OF THE INVENTION

Field of the Invention

The present invention relates to a processing time predicting method for predicting the processing time required to detect posture interference between two robots operated within the same operation time period.

Description of the Related Art

In Japanese Laid-Open Patent Publication No. 2012-106316, as described below, a method is disclosed for detecting the presence or absence of interference between two articulating robots arranged mutually adjacent to each other. To provide a simplified description, the two articulated robots are modeled and indicated in a virtual space by a computer, and together therewith, a posture of one of the articulated robots in the virtual space is obtained for each of predetermined times within an operation time period. Further, with respect to each of respective postures thereof, the postures of the other articulated robot at each of the predetermined times within the operation time period are compared by brute force, and the presence or absence of interference between the one articulated robot and the other articulated robot is detected.

### SUMMARY OF THE INVENTION

There has been a demand to predict with high accuracy the processing time required for such processes, prior to actually performing the processes of determining the postures of two articulated robots at each of the predetermined times, and detecting the presence or absence of interference by comparing the determined postures.

Thus, the present invention has the object of providing a processing time predicting method for predicting with high accuracy the processing time spent in calculating the postures of two articulated robots and detecting interference between the two articulated robots.

The present invention is characterized by a processing time prediction method for predicting a processing time for determining postures of a first robot and a second robot, and detecting presence or absence of posture interference between the first robot and the second robot, at a plurality of specified checkpoints specified from among a plurality of checkpoints defined by segmenting a same operation time period in which operations of the first robot and the second robot are carried out into each of respective predetermined time intervals. The method includes a sampling point setting step of setting a plurality of sampling points defined by segmenting the operation time period into respective sampling time intervals, which are longer than the predetermined time intervals, a first calculation and measurement step of calculating a posture assumed by the first robot and a posture assumed by the second robot for each of the plurality of sampling points, and measuring and integrating a posture calculation time required for posture calculations, a second calculation and measurement step of calculating the posture assumed by the first robot and the posture assumed by the second robot for each of the sampling points, detecting the presence or absence of interference based on the posture assumed by the first robot and the posture assumed by the second robot, and measuring and integrating a posture calculation and interference detection time required for the posture calculation and the interference detection, an interference detection time computation step of computing an interference detection time of the interference detections required at the plurality of sampling points, from a difference between the posture calculation and interference detection time and the posture calculation time, and a unit processing time computation step of computing a unit time by dividing the interference detection time by a number of the plurality of sampling points, and establishing the unit time as a unit processing time required for the posture calculation and the interference detection at one of the checkpoints.

The present invention is further characterized by the above-described processing time prediction method, in which the sampling time interval is an integral multiple of the predetermined time interval.

According to the present invention, it is possible to determine with high accuracy the unit processing time required to perform the posture calculation and to detect interference at one of the checkpoints. By using the unit processing time, it is possible to predict with high accuracy the processing time spent in detecting the presence or absence of interference between the postures of two articulated robots.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an overall configuration diagram of robot devices and an interference detecting device;

FIG. 2 is an external configuration diagram of a robot shown in FIG. 1;

FIG. 3 is a view for describing interference detection between two robots, which has been performed conventionally;

FIG. 4 is a functional block diagram of a control device shown in FIG. 1;

FIG. 5 is a view showing a time region which is determined based on rough checkpoints for which the possibility for the rough checkpoints and interference are judged to be high;

FIG. 6 is a view showing a time region which is determined based on sampling points for which the possibility for the sampling points and interference are judged to be high; and

FIG. 7 is a view showing schematically a processing time, a posture calculation and interference detection time, and an interference detection time.

### DESCRIPTION OF THE PREFERRED EMBODIMENTS

A preferred embodiment concerning the processing time prediction method according to the present invention will be described in detail below with reference to the accompanying drawings.

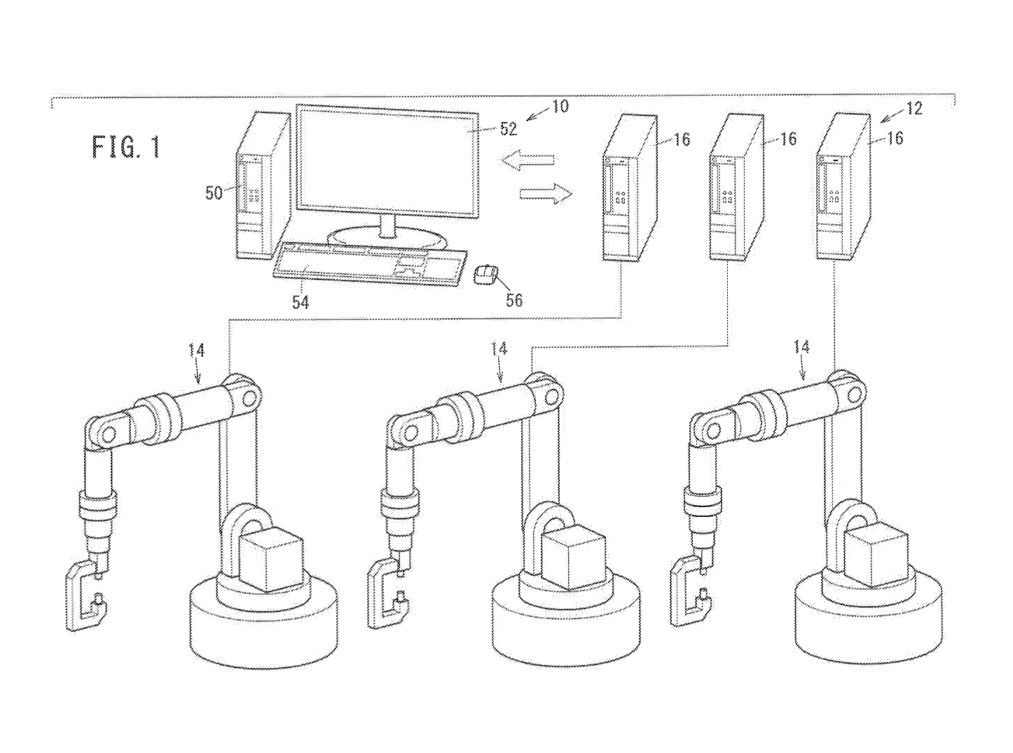

FIG. 1 is an overall configuration diagram of an interference detecting device (processing time predicting device) 10 and robot devices 12. The interference detecting device 10 creates teaching data for performing motion controls of each of a plurality of articulated robots 14 that make up the robot devices 12. In addition, the interference detecting device 10 detects in a virtual space, based on the plurality of teaching data, the presence or absence of interference (whether or not the possibility for interference is high) between two of the articulated robots 14 for which there is a concern of interference therebetween when the plurality of articulated robots 14 are operated. Further, prior to detecting the presence or absence of posture interference between the two articulated robots 14, the interference detecting device 10 predicts the processing time required for such processing. As for the two articulated robots 14 for which there is a concern of interference, these correspond, for example, to two of the articulated robots 14 within a predetermined distance range, or two of the articulated robots 14 disposed adjacent to each other, etc.

The interference detecting device 10 is capable of performing data communications with the robot devices 12. The robot devices 12 comprise the plurality of articulated robots 14 (hereinafter referred to simply as “robots”), and a plurality of robot controllers 16 that perform respective motion controls for the plurality of robots 14 on the basis of the plural teaching data created by the interference detecting device 10. A device other than the interference detecting device 10 may also be used to generate the teaching data. For example, the plurality of robot controllers 16 may create the plural teaching data, or an external device (computer) other than the interference detecting device 10 and the robot devices 12 may create the plural teaching data. In this case, the interference detecting device 10 acquires the plural teaching data from a device (a controller of a computer or the like) that creates the plural teaching data.

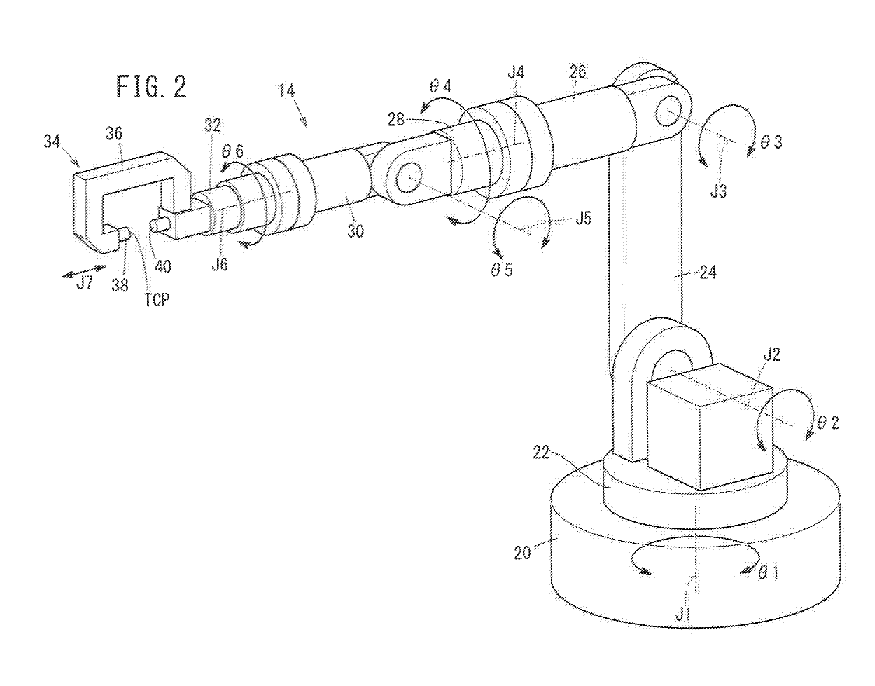

FIG. 2 is an external configuration diagram of a robot 14. Although according to the present embodiment, the plurality of robots 14 are robots each having the same structure, they also may be constituted differently from each other. Each of the robots 14 includes a first base 20 that serves as a mounting platform, a second base 22, a first link 24, a second link 26, a third link 28, a fourth link 30, and an end effector attachment/detachment part 32. These components are connected in this order from the first base 20 to the distal end side. An end effector 34 is mounted on the distal end effector attachment/detachment part 32. Although according to the present embodiment, a gun unit that performs welding is used as the end effector 34, the invention is not limited to this feature.

The second base 22 is pivotally supported on the first base 20 so as to be pivotable (rotatable) about an axis J1, which is a vertical axis parallel to the direction of gravity. A proximal end portion of the first link 24 is pivotally supported on the second base 22, and is capable of moving up and down (is rotatable) about an axis J2, which is a horizontal axis parallel to a plane orthogonal to the direction of gravity. Further, a proximal end portion of the second link 26 is pivotally supported on the distal end of the first link 24, and is capable of moving up and down (is rotatable) about an axis J3 parallel to the axis J2. The third link 28 is pivotally supported on a distal end of the second link 26, and is capable of rotating about an axis J4 along a direction (longitudinal direction) that runs from the proximal end to the distal end of the third link 28. A proximal end portion of the fourth link 30 is pivotally supported on the distal end of the third link 28, and is capable of rotating about an axis J5 parallel to the axis J2 and the axis J3. The end effector attachment/detachment part 32 is pivotally supported on a distal end of the fourth link 30, and is capable of rotating about an axis J6 along a direction that runs from the proximal end to the distal end of the end effector attachment/detachment part 32.

According to the present embodiment, a so-called C-type welding gun is used as the end effector 34. A pair of electrodes 38, 40 that open and close along a gun axis J7 are provided on both ends of an arch-shaped arm 36 that constitutes the C-type welding gun. In a closed state, the electrodes 38, 40 are brought into contact with a non-illustrated workpiece at a working point, hereinafter referred to as a TCP (Tool Center Point) of the gun axis J7.

Rotation of the second base 22, the first link 24, the second link 26, the third link 28, the fourth link 30, and the end effector attachment/detachment part 32 about the shafts J1 through J6, and the opening and closing of the electrodes 38 and 40 are performed by non-illustrated actuators. The three-dimensional coordinate position of the TCP is determined by angles of rotation θ1 to θ6 of the axes J1 through J6, the shape and dimensions of respective components of the robots 14, and the shape and dimensions of the end effector 34. The welding gun may also be a so-called X-type welding gun.

Returning to the description of FIG. 1, the interference detecting device 10 comprises a controller 50, a display (display device) 52, a keyboard 54, and a mouse 56. The controller 50 is constituted by a computer having a CPU or the like, and a memory, etc. The computer functions as the controller 50 of the present embodiment by executing programs stored in the memory. The display 52 serves to display images, and is constituted, for example, by a liquid crystal display, an organic EL display, or the like. The keyboard 54 and the mouse 56 function as input/output devices that input and output information. It should be noted that there may be a plurality of such interference detecting devices 10.

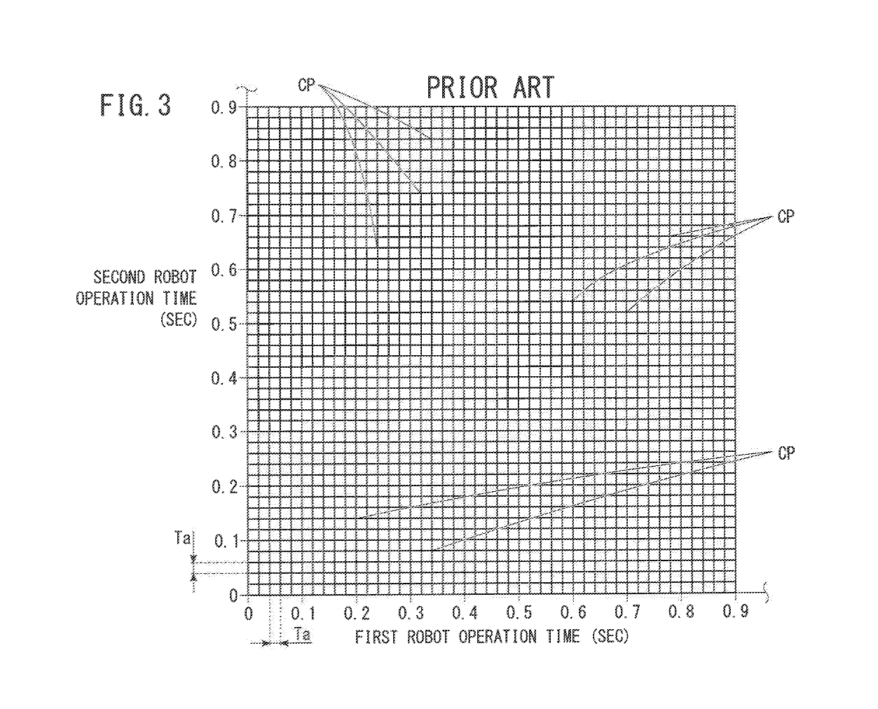

Before giving a detailed description of the interference detecting device 10, a description will be given with reference to FIG. 3 concerning detection of interference between the two robots 14 as carried out according to the conventional method. FIG. 3 is a view for describing the detection of presence or absence of interference, by computing respective postures of the two robots 14 from the start of operations until the end of operations within the same operation time period and compared the postures by brute force. In FIG. 3, the operation time period (movement time period) of one of the robots 14 (hereinafter referred to as a “first robot 14a”) from among the two robots 14 is shown on the horizontal axis, and the operation time period (movement time period) of the other of the robots 14 (hereinafter referred to as a “second robot 14b”) is shown on the vertical axis. The operation time period of the first robot 14a and the operation time period of the second robot 14b are the same. In addition, at each of a plurality of checkpoints CP (predetermined times) defined by segmenting the operation time period into respective predetermined time periods (e.g., 0.02 seconds) Ta, the postures of the first robot 14a and the second robot 14b are determined and compared by brute force, and the presence or absence of interference (whether or not the possibility for interference is high) is detected.

The checkpoints CP are defined by intersections between lines (predetermined times) at which the operation time period of the first robot 14a indicated on the horizontal axis is segmented into respective predetermined time periods (predetermined time intervals) Ta, and lines (predetermined times) at which the operation time period of the second robot 14b indicated on the vertical axis is segmented into respective predetermined time periods (predetermined time intervals) Ta. Consequently, the multiple checkpoints CP can be indicated as a collection of points arranged in the form of a matrix, in which the flow of the operation time period of the first robot 14a is set in the direction of columns, and the flow of the operation time period of the second robot 14b is set in the direction of rows. The posture calculations for the first robot 14a are performed based on teaching data for carrying out motion controls of the first robot 14a, and the posture calculations for the second robot 14b are performed based on teaching data for carrying out motion controls of the second robot 14b.

More specifically, the posture of the first robot 14a at a predetermined time is obtained, the posture of the second robot 14b at the start of operations is obtained, and the presence or absence of interference between the postures of the first robot 14a and the second robot 14b is detected. Then, in a state in which the posture of the first robot 14a is kept as is, the posture in relation to the second robot 14b is determined after elapse of the predetermined time period Ta from the posture thereof when the presence of absence of interference was detected the previous time, and operations to detect the presence of absence of interference between the postures of the first robot 14a and the second robot 14b are carried out until a time at which the operations of the second robot 14b are completed. In addition, such operations are carried out with respect to each of predetermined times (the time intervals thereof are the predetermined time periods Ta) from the start of operations until the completion of operations of the first robot 14a. In other words, the postures of the first robot 14a at each of predetermined times are obtained in chronological order, and the postures of the second robot 14b at each of the predetermined times are obtained in chronological order with respect to the respective postures of the first robot 14a, and the presence or absence of interference therebetween is detected. By performing such operations, it is possible to efficiently detect by brute force the presence or absence of interference between the postures of the first robot 14a and the postures of the second robot 14b at each of the checkpoints CP shown in FIG. 3.

However, when the predetermined time period Ta, which is the time interval between the checkpoints CP, is 0.02 seconds, the number of times that processing for detecting the presence or absence of interference is carried out increases, and the processing time becomes enormous. Further, if the predetermined time period Ta is set to a relatively long time (for example, 2 seconds), although the processing time can be suppressed, the accuracy of the posture interference detection decreases. Thus, in the aforementioned Japanese Laid-Open Patent Publication No. 2012-106316, in principle, the time interval between the checkpoints CP is set at the predetermined time period Ta of 0.02 seconds, whereas in a time region (a collection of checkpoints CP) in which the concern of interference is small, by setting the predetermined time period Ta to be longer than 0.02 seconds and reducing the density of the checkpoints CP, the processing time required for posture calculation and interference detection is reduced. On the other hand, there is a demand for predicting the processing time prior to carrying out such posture calculations and interference detections.

For example, five robots 14 are arranged in the order of a robot 14₁, a robot 14₂, a robot 14₃, a robot 14₄, and a robot 14₅ along a working line (manufacturing line). In addition, posture calculation and interference detection between the robots 14₁, 14₂, posture calculation and interference detection between the robots 14₂, 14₃, posture calculation and interference detection between the robots 14₃, 14₄, and posture calculation and interference detection between the robots 14₄, 14₅ are carried out. In this case, two of the interference detecting devices 10 are prepared, and posture calculation and interference detection between the robots 14₁, 14₂, and posture calculation and interference detection between the robots 14₂, 14₃ are performed by one of the interference detection devices 10 (10a), whereas posture calculation and interference detection between the robots 14₃, 14₄, and posture calculation and interference detection between the robots 14₄, 14₅ are performed by another of the interference detection devices 10 (10b), whereby it is possible to shorten the overall processing time.

However, in the case that the processing time spent for posture calculation and interference detection between the robots 14₁, 14₂ is assumed to be “1”, then if the processing time spent for posture calculation and interference detection between the robots 14₂, 14₃ is “1”, together with the processing time spent for posture calculation and interference detection between the robots 14₃, 14₄ and between the robots 14₄, 14₅ being “2”, in contrast to the total processing time by the interference detecting device 10a being “2”, the total processing time by the interference detecting device 10b becomes “4”. In order to equalize the total processing time spent by the interference detection devices 10a and 10b, it is desirable to predict the time required for posture calculation and interference detection between the respective robots 14. In addition, based on the prediction result, by allocating the posture calculations and the interference detections carried out between the respective robots 14 to the plurality of interference detection devices 10, the processing time required for the posture calculations and the interference detections of each of the interference detection devices 10 can be equally allocated, and the total processing time can be shortened.

In this regard, Japanese Laid-Open Patent Publication No. 2008-020642 discloses a method for predicting data processing times. To provide a simplified description, a representative sample is selected, and data processing is executed on the plurality of representative samples. Further, a unit processing time is determined based on a time required for data processing of the plurality of representative samples, and by multiplying the unit processing time by the total number of processes, the total processing time is predicted.

If the operations or movements of the robots 14 are segmented into each of respective minute predetermined time periods (e.g., 0.02 seconds each) Ta, and the postures at such segmented predetermined time intervals are calculated in chronological order, the time spent for the posture calculations of the robots 14 can be ignored, since it is extremely short in comparison with the time required for detecting the presence or absence of interference between the postures of the robots 14. As reasons therefor, this is because there is no significant change between the postures of the robots 14 at the present time and the postures of the robots 14 after elapse of the predetermined time period (for example, 0.02 seconds) Ta. However, in the case that the operation times of the robots 14 are segmented into sampling time periods (e.g., 2 seconds each) which are longer than the predetermined time period Ta, and the postures at each of such segmented sampling time intervals are calculated in chronological order, the time spent for the posture calculations of the robots 14 becomes longer. Consequently, the time spent for the posture calculations with respect to the time required for detecting the presence or absence of interference between the postures of the robots 14 cannot be ignored. As reasons therefor, this is because, since the sampling time period is a long interval of 2 seconds, there is a possibility for significant changes between the postures of the robots 14 at the present time and the postures of the robots 14 after elapse of the sampling time period (the time interval of 2 seconds). Consequently, since the objects of the process differ significantly between the present embodiment and that of Japanese Laid-Open Patent Publication No. 2008-020642 (graphical data is the object according to Japanese Laid-Open Patent Publication No. 2008-020642, whereas posture calculation for the robots 14 is the object according to the present embodiment), it is impossible to directly adopt the technical concept of Japanese Laid-Open Patent Publication No. 2008-020642. Hence, according to the present embodiment, the processing time required for detecting the presence or absence of interference between two articulated robots 14 is predicted with high accuracy.

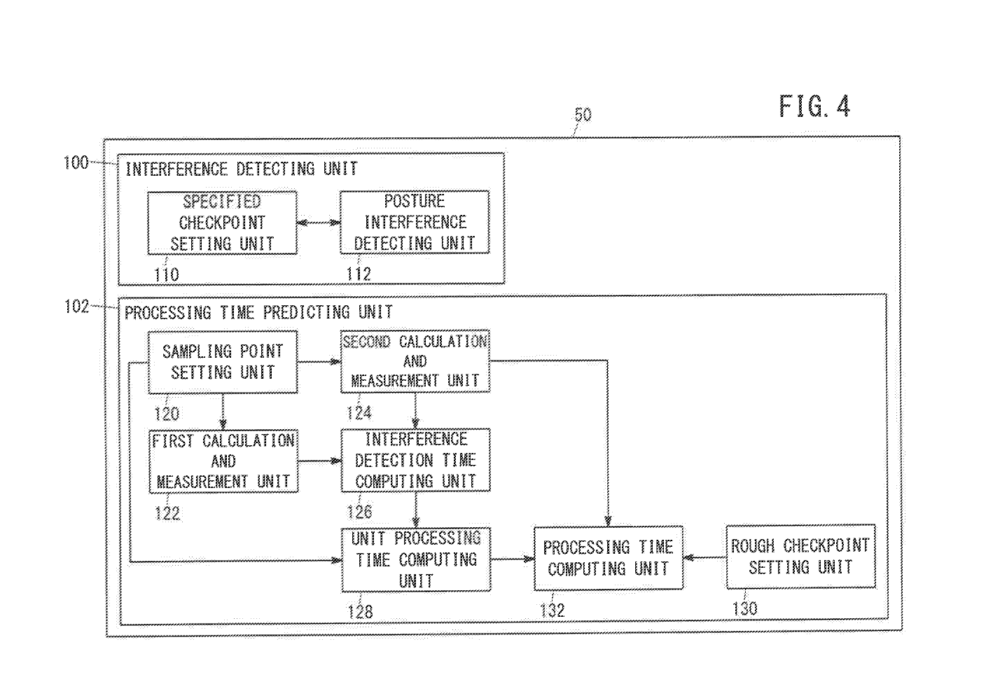

FIG. 4 is a functional block diagram of a controller 50 of the interference detecting device 10. The controller 50 comprises an interference detecting unit 100 and a processing time predicting unit 102. The interference detecting unit 100 carries out posture calculations and interference detections between the two robots 14 in a virtual space on the basis of teaching data. Using the teaching data, the processing time predicting unit 102 predicts the processing time S required for the posture calculations and the interference detections performed by the interference detecting unit 100. Although the prediction of the processing time S performed by the processing time predicting unit 102 is carried out before the posture calculations and the interference detections by the interference detecting unit 100, at first, a description will be given concerning the interference detecting unit 100, and thereafter, a description will be given concerning the processing time predicting unit 102.

The interference detecting unit 100 is equipped with a specified checkpoint setting unit 110 and a posture interference detecting unit 112. The specified checkpoint setting unit 110 sets as specified checkpoints CCP a plurality of rough checkpoints RCP defined by segmenting the operation time periods of the first robot 14a and the second robot 14b into rough time periods (rough time intervals) Tb that are longer than the aforementioned predetermined time periods Ta. The specified checkpoint setting unit 110 outputs to the posture interference detecting unit 112 position information (position information on a time axis) of the set plurality of specified checkpoints CCP (rough checkpoints RCP).

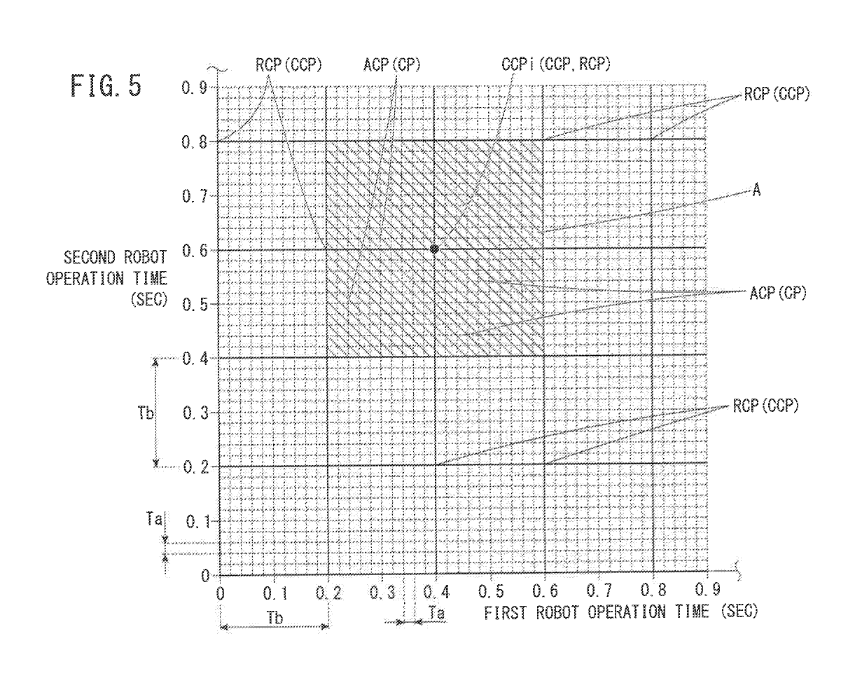

As shown in FIG. 5, rough checkpoints RCP (specified checkpoints CCP) are intersections between lines (rough check times) at which the operation time period of the second robot 14b defined on the horizontal axis is segmented into respective rough time periods Tb, and lines (rough check times) at which the operation time period of the first robot 14a defined on the vertical axis is segmented into respective rough time periods Tb. Consequently, the multiple specified checkpoints CCP can be indicated as a collection of points arranged in the form of a matrix, in which the flow of the operation time period of the first robot 14a is set in the direction of columns, and the flow of the operation time period of the second robot 14b is set in the direction of rows. In the present embodiment, since there are 180 individual specified checkpoints in the direction of the columns and the direction of the rows, the total number of specified checkpoints CCP is 32400. Further, according to the present embodiment, the predetermined time period (predetermined time interval) Ta is set to 0.02 seconds, and the rough time period Tb is set to 0.2 seconds. Further, concerning the predetermined times (the time intervals thereof are the predetermined time periods Ta) and the rough check times (the time intervals thereof are the predetermined time periods Tb), the timings thereof are synchronized. In the foregoing manner, the specified checkpoints CCP (rough checkpoints RCP) are obtained by thinning out the plural checkpoints CP, which are defined by segmenting the operation times of the first robot 14a and the second robot 14b into each of predetermined time periods Ta, by 1/100 (i.e., by 1/10 in each of the horizontal axis direction and the vertical axis direction). Further, according to the present embodiment, although the rough time period Tb is set to ten times the predetermined time period Ta, it may be any integral multiple of the predetermined time period Ta.

The posture interference detecting unit 112 determines the postures of the first robot 14a and the second robot 14b at each of the set plurality of specified checkpoints CCP, together with detecting by brute force the presence or absence of interference on the basis of the postures assumed by the first robot 14a and the postures assumed by the second robot 14b. More specifically, in a state in which the posture assumed by the first robot 14a at a given rough check time is computed, and the computed posture of the first robot 14a is fixed, the postures of the second robot 14b are computed in chronological order and the presence or absence of interference is detected at respective rough check times (the time intervals thereof are the rough time periods Tb) from the start of operations until the end of operations of the second robot 14b. Such operations are carried out in chronological order at the respective rough check times from the start of operations until the end of operations of the first robot 14a.

Stated otherwise, the posture interference detecting unit 112 carries out the operations of computing the posture assumed by the first robot 14a at a given column of rough checkpoints RCP (specified checkpoints CCP), and subsequently, chronologically computes the postures assumed by the second robot 14b at respective rough checkpoints RCP from the 1st to the 180th rows, together with detecting the presence or absence of interference in chronological order. These operations are performed from the 1st to the 180th columns. By performing such operations, posture calculations and detection of interference of the first robot 14a and the second robot 14b at all of the set rough checkpoints RCP can be performed efficiently.

In addition, the posture interference detecting unit 112 outputs to the specified checkpoint setting unit 110 the position information (position information on a time axis) of the rough checkpoints RCP (specified checkpoints CCP) for which it is judged that the possibility for interference is high.

A description will now be given of the interference detection performed by the posture interference detecting unit 112. The posture interference detecting unit 112 computes the shortest distance between the first robot 14a and the second robot 14b from the postures of the first robot 14a and the second robot 14b that were computed at the respective checkpoints CCP. In addition, it is judged to be near (the possibility for interference is high at times around the shortest distance) if the shortest distance is less than or equal to a threshold value (for example 400 mm), and it is judged to be far (the possibility for interference is low) if the shortest distance is longer than the threshold value.

The specified checkpoint setting unit 110 additionally sets a plurality of checkpoints CP as specified checkpoints, on the basis of position information of the specified checkpoints CCP (hereinafter indicated by CCPi) that were judged to be near (the possibility for interference is high at times around the shortest distance). Such added specified checkpoints are represented by ACP. The specified checkpoint setting unit 110 additionally sets as specified checkpoints ACP a plurality of checkpoints CP inside of a time region A specified by a period of approximately 0.2 seconds before and after on the horizontal axis and the vertical axis, and centered about a position of specified checkpoints CCPi that were judged as being near (the possibility for interference is high). The time region A is a block region of 0.4 seconds with respect to the horizontal axis direction and the vertical axis direction of FIG. 5, respectively. In FIG. 5, the time region A is indicated by hatching. Due to the fact that the checkpoints CP are defined by segmenting the operation times of the first robot 14a and the second robot 14b into each of predetermined time periods (0.02 seconds), the number of checkpoints CP within the time region A is 400 (=20 on the horizontal axis×20 on the vertical axis). If there are a plurality of the specified checkpoints CCPi determined as being near (the possibility for interference is high), the specified checkpoint setting unit 110 specifies a plurality of time regions A based on the respective checkpoints CCPi, and additionally sets as specified checkpoints ACP the checkpoints CP inside of the plural time regions A. However, even if there are checkpoints CP inside of the time regions A, they are not newly added as specified checkpoints ACP with respect to the specified checkpoints CCP, ACP that have already been set. The specified checkpoint setting unit 110 again outputs to the posture interference detecting unit 112 the position information (position information on a time axis) of the additionally set specified checkpoints ACP.

The posture interference detecting unit 112 determines the postures of the first robot 14a and the second robot 14b in the manner noted above, at each of the set plurality of specified checkpoints ACP, together with detecting by brute force using the shortest distance thereof the presence or absence of interference (whether or not the possibility for interference is high), on the basis of the postures assumed by the first robot 14a and the postures assumed by the second robot 14b. In this manner, the posture interference detecting unit 112 determines the postures of the first robot 14a and the second robot 14b at the specified checkpoints CCP, ACP, which are plural checkpoints CP specified from among the plurality of checkpoints CP, and detects by brute force the presence or absence of interference between the first robot 14a and the second robot 14b. In accordance with this feature, within the region A in which it is judged that the shortest distance between the two robots 14 is comparatively near, and around a time in which the possibility for interference is high, the shortest distance is confirmed at small intervals, and since observations are not made finely when the shortest distance is far, the processing time required for posture calculation and detection of interference can be shortened without degrading the accuracy in determining the presence or absence of interference. The final presence or absence of interference (presence or absence of collision) may be determined in consideration of errors in operations, vibrations of the robots 14, the model accuracy of the robots 14 in the virtual space, etc. For example, a determination may be made as to whether or not the shortest distance between the robots 14 is a predetermined distance or greater, and for example, if the predetermined distance is less than or equal to 50 mm, “presence of interference” is set.

Next, a description will be given concerning the processing time predicting unit 102. The processing time predicting unit 102 is equipped with a sampling point setting unit 120, a first calculation and measurement unit 122, a second calculation and measurement unit 124, an interference detection time computing unit 126, a unit processing time computing unit 128, a rough checkpoint setting unit 130, and a processing time computing unit 132.

The sampling point setting unit 120 sets a plurality of sampling points SP, which are defined by segmenting the operation time of the first robot 14a and the second robot 14b into respective sampling time periods (sampling time intervals) Tc, which are longer than the aforementioned predetermined time period Ta and the rough time period Tb. The sampling point setting unit 120 outputs to the first calculation and measurement unit 122, the second calculation and measurement unit 124, and the unit processing time computing unit 128 position information (position information on a time axis) of the set plurality of sampling points SP.

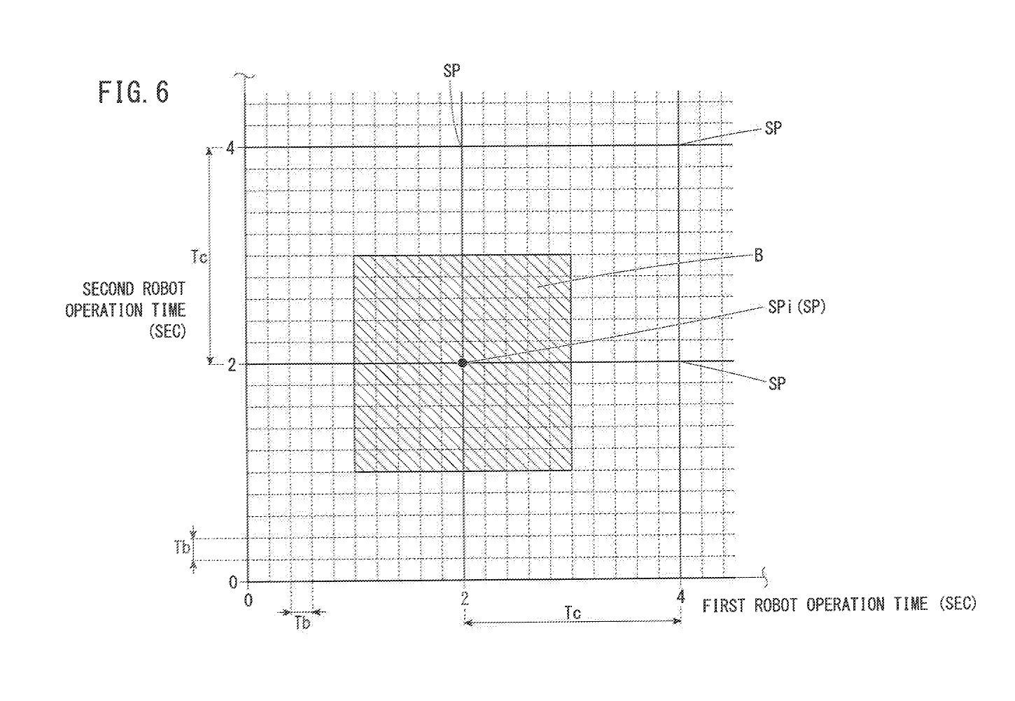

As shown in FIG. 6, the sampling points SP are intersections between lines (sampling times) at which the operation time period of the first robot 14a defined on the horizontal axis is segmented into respective sampling time periods Tc, and lines (sampling times) at which the operation time period of the second robot 14b defined on the vertical axis is segmented into respective sampling time periods Tc. Consequently, the multiple sampling points SP can be indicated as a collection of points arranged in the form of a matrix, in which the flow of the operation time period of the first robot 14a is set in the direction of columns, and the flow of the operation time period of the second robot 14b is set in the direction of rows. In the present embodiment, since there are 18 individual sampling points SP in the direction of the columns and the direction of the rows, the total number of sampling points SP is 324. Further, according to the present embodiment, the sampling time period (sampling time interval) Tc is set to 2.0 seconds, and concerning the predetermined times (the time intervals thereof are the predetermined time periods Ta) and the sampling times (the time intervals thereof are the sampling time periods Tc), the timings thereof are synchronized. In the foregoing manner, the sampling points SP are obtained by thinning out the plural checkpoints CP, which are defined by segmenting the operation times of the first robot 14a and the second robot 14b into each of predetermined time periods Ta, by 1/10000 (i.e., by 1/100 in each of the horizontal axis direction and the vertical axis direction). Further, according to the present embodiment, although the sampling period Tc is set to 100 times the predetermined time period Ta, it may be any integral multiple of the predetermined time period Ta.

The first calculation and measurement unit 122 determines the postures of the first robot 14a and the second robot 14b at each of the set plurality of sampling points SP. More specifically, in a state in which the first calculation and measurement unit 122 computes the posture assumed by the first robot 14a at a given sampling time, and the computed posture of the first robot 14a is fixed, the first calculation and measurement unit 122 carries out the operations of chronologically computing the postures of the second robot 14b at respective sampling times (the time intervals thereof are the sampling periods Tc) from the start of operations until the end of operations of the second robot 14b, in chronological order at respective sampling times from the start of operations until the end of operations of the first robot 14a.

Stated otherwise, the first calculation and measurement unit 122 carries out the operations of computing the posture assumed by the first robot 14a at a given column of sampling points SP, and subsequently, chronologically computes the postures assumed by the second robot 14b at respective sampling points SP from the 1st to the 18th rows, and then the operations are performed in chronological order from the 1st to the 18th columns. By performing such operations, posture calculations of the first robot 14a and the second robot 14b at all of the set sampling points SP can be performed efficiently. Additionally, the first calculation and measurement unit 122 measures the total time (hereinafter referred to as a “posture calculation time”) required for such posture calculations. The posture calculation time is the time period in which the times spent in calculating the postures of the first robot 14a and the second robot 14b at each of the plurality of sampling points SP are measured and integrated (added up). The first calculation and measurement unit 122 outputs the measured posture calculation time to the interference detection time computing unit 126.

The second calculation and measurement unit 124 determines the postures of the first robot 14a and the second robot 14b at each of the set plurality of sampling points SP, together with detecting the presence or absence of interference on the basis of the postures assumed by the first robot 14a and the postures assumed by the second robot 14b. More specifically, in a state in which the second calculation and measurement unit 124 computes the posture assumed by the first robot 14a at a given sampling time, and the computed posture of the first robot 14a is fixed, the second calculation and measurement unit 124 computes the postures of the second robot 14b at respective sampling times from the start of operations until the end of operations of the second robot 14b in chronological order, together with detecting the presence or absence of interference. Such operations are performed at respective sampling times from the start of operations until the end of operations of the first robot 14a.

Stated otherwise, the second calculation and measurement unit 124 carries out the operations of computing the posture assumed by the first robot 14a at a given column of a sampling point SP, and subsequently, chronologically computes the postures assumed by the second robot 14b at respective sampling points SP from the 1st to the 18th rows, together with detecting the presence or absence of interference. Then, such operations are performed in chronological order from the 1st to the 18th columns. By performing such operations, posture calculations and detection of interference of the first robot 14a and the second robot 14b at all of the sampling points SP can be performed efficiently. Additionally, the second calculation and measurement unit 124 measures the total time (hereinafter referred to as a “posture calculation and interference detection time”) required for such posture calculations and detection of interference. The posture computation and interference detection time is the time period in which the times spent in calculating the postures and detecting interference of the first robot 14a and the second robot 14b at each of the plurality of sampling points SP are measured and integrated (added up). The second calculation and measurement unit 124 outputs the computed posture calculation and interference detection time to the interference detection time computing unit 126.

Although it goes without saying, the first calculation and measurement unit 122 and the second calculation and measurement unit 124 perform the posture calculations for the first robot 14a based on teaching data for carrying out motion controls of the first robot 14a, and perform the posture calculations for the second robot 14b based on teaching data for carrying out motion controls of the second robot 14b. Since the specific method of such posture calculations makes use of well-known technology, explanation thereof is omitted.

Next, the interference detection performed by the second calculation and measurement unit 124 is the same as that of the posture interference detecting unit 112. Stated otherwise, the second calculation and measurement unit 124 computes the shortest distance between the first robot 14a and the second robot 14b from the postures of the first robot 14a and the second robot 14b that were computed at the respective sampling points SP. In addition, it is judged to be near (the possibility for interference is high) if the shortest distance is less than or equal to a threshold value (for example, 400 mm), and it is judged to be far (the possibility for interference is low) if the shortest distance is longer than the threshold value. The second calculation and measurement unit 124 outputs to the processing time computing unit 132 the position information (position information on a time axis) of the sampling points SP (hereinafter indicated by SPi) that have been judged to be near (the possibility for interference is high).

By subtracting the posture calculation time from the posture calculation and interference detection time, the interference detection time computing unit 126 computes a time (hereinafter referred to as an “interference detection time”) required only to detect the presence or absence of interference. In addition, the unit processing time computing unit 128 computes a unit processing time PS by dividing the interference detection time by the number of the sampling points SP. The unit processing time PS indicates a time required for interference detection at one point (sampling point SP, checkpoint CP, and rough checkpoint RCP). Moreover, the unit processing time computing unit 128 determines the number of sampling points SP based on position information of the multiple sampling points SP, which were transmitted from the sampling point setting unit 120 and set.

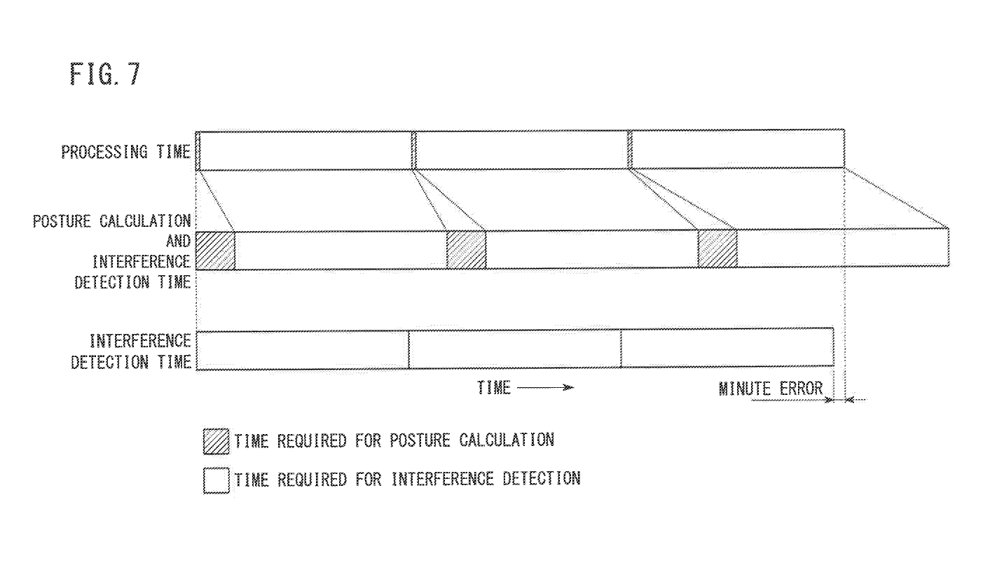

FIG. 7 is a view showing schematically a processing time in the case that posture calculations and interference detections are carried out at respective predetermined times (or rough check times) defined by segmenting the operation time into each of respective predetermined time periods Ta (or rough time periods Tb), a posture calculation and interference detection time in the case that posture calculations and interference detections are carried out at respective sampling times (sampling points SP) defined by segmenting the operation time into each of respective sampling time periods Tc, and an interference detection time. In FIG. 7, for facilitating comparison between the processing time, the posture calculation and interference detection time, and the interference detection time, the required processing times, the posture calculation and interference detection times, and the interference detection times are indicated at three consecutive checkpoints CP (or rough checkpoints RCP) and sampling points SP.

In the case that posture calculations and interference detections are carried out at each of respective predetermined times (or rough check times), because the predetermined time periods Ta (or the rough time periods Tb) are extremely short time periods of 0.02 seconds (or 0.2 seconds), the postures of the robots 14 do not change significantly during the predetermined time periods Ta (or the rough time periods Tb), and the time required for the posture calculation at each of the predetermined times (or rough check times) is short. On the other hand, in the case that the posture calculations and interference detections are carried out at each of the respective sampling times, because the sampling time periods Tc are long time periods of 2 seconds, cases occur in which the postures of the robots 14 change significantly during the sampling time periods Tc, and the time spent in performing the posture calculations is long. Between both of the predetermined times and the sampling times, it should be noted that there is almost no difference in the time required to detect the presence or absence of interference.

Therefore, as shown in FIG. 7, the posture calculation and interference detection time required in the case that the posture calculations and interference detections are performed at the three sampling points SP includes a large error with respect to the processing times required in the case that posture calculations and interference detections are performed at the three checkpoints CP (rough checkpoints RCP). Consequently, even if the unit processing time PS required for one posture calculation and interference detection is determined simply by dividing the posture calculation and interference detection time required for a plurality of sampling points SP by the number of sampling points SP, the error becomes large with respect to the time required for posture calculation and interference detection at one checkpoint CP (rough checkpoint RCP). In particular, the number of checkpoints CP and rough checkpoints RCP is overwhelmingly large in comparison with the number of sampling points SP, and at a maximum, the number of checkpoints CP and rough checkpoints RCP is approximately 10000 times or 100 times the number of sampling points SP. Consequently, in the case that the processing time is computed using the unit processing time PS obtained by dividing the posture calculation and interference detection time required for the plurality of sampling points SP by the number of sampling points SP, the error thereof becomes so large that it cannot be ignored.

Therefore, by subtracting the posture calculation time from the posture calculation and interference detection time, the interference detection time required only to detect the presence or absence of interference is computed. As shown in FIG. 7, the interference detection time required to perform the interference detections at the three sampling points SP is short in comparison with the processing time required in the case that posture calculations and interference detections are performed at the three checkpoints CP (or rough checkpoints RCP). However, such an error is minute and falls within an allowable range. More specifically, since the time required for the posture calculations at the checkpoints CP (rough checkpoints RCP) is extremely short, even if the time required for such posture calculations is ignored, the error thereof falls within an allowable range. Consequently, a unit processing time PS is computed by dividing the interference detection time by the number of sampling points SP.

The rough checkpoint setting unit 130 sets a plurality of rough checkpoints RCP defined by segmenting the operation time periods of the first robot 14a and the second robot 14b into rough time periods (rough time intervals) Tb that are longer than the aforementioned predetermined time periods Ta but shorter than the sampling time periods Tc. The rough checkpoint setting unit 130 outputs to the processing time computing unit 132 the number N1 of rough checkpoints RCP that have been set. The method for setting the rough checkpoints RCP used by the rough checkpoint setting unit 130 is the same as the method for setting the specified checkpoints CCP (rough checkpoints RCP) used by the specified checkpoint setting unit 110.

The processing time computing unit 132 predicts the processing time S during which the posture interference detecting unit 112 determines the postures of the first robot 14a and the second robot 14b at the specified checkpoints CCP, ACP, and detects the presence or absence of posture interference between the first robot 14a and the second robot 14b.

The processing time computing unit 132 selects a plurality of checkpoints CP, on the basis of the position information of the sampling points SPi for which it was judged by the second calculation and measurement unit 124 that the possibility for interference is high. More specifically, in relation to the first robot 14a and the second robot 14b, a plurality of checkpoints CP are selected inside of the time region B specified by a period of approximately 1 second before and after on the horizontal axis and the vertical axis, and centered about the position of the sampling points SPi. The time region B is a block region of 2 seconds with respect to the horizontal axis direction and the vertical axis direction of FIG. 6, respectively. In FIG. 6, the time region B is indicated by hatching. Due to the fact that the checkpoints CP are defined by segmenting the operation times of the first robot 14a and the second robot 14b into each of predetermined time periods (0.02 seconds), the number of checkpoints CP within the time region B is 10000 (=100 on the horizontal axis×100 on the vertical axis). Consequently, if the number of sampling points SPi for which it is determined that the possibility for interference is high is set to n, then the number N2 of all of the selected checkpoints CP can be represented by the relational expression N2=10000×n.

In addition, the processing time computing unit 132 computes the processing time S by multiplying the unit processing time PS by a value obtained by adding the number N2 of the selected checkpoints CP and the number N1 of rough checkpoints RCP set by the rough checkpoint setting unit 130. Stated otherwise, the processing time computing unit 132 computes the processing time S using the relational expression S=(N1+N2)×PS.

In the foregoing manner, the posture interference detecting unit 112 carries out the posture calculations and interference detections for the first robot 14a and the second robot 14b at each of the plurality of specified checkpoints CCP (rough checkpoints RCP). In addition, the plurality of checkpoints CP are additionally set as specified checkpoints ACP inside of a time region A specified by a period of approximately 0.2 seconds before and after on the horizontal axis and the vertical axis, centered about a position of specified checkpoint CCPi that was judged as having a high possibility for interference. The posture interference detecting unit 112 further performs the posture calculations and interference detections at the specified checkpoints ACP that are additionally set.

In contrast thereto, as a method for computing the processing time required to perform posture calculations and interference detections in the posture interference detection unit 112 in advance, the processing time computing unit 132 adds the number N2 of the plurality of checkpoints CP inside of the time region B, which is set to a period between approximately 1 second before and after the sampling point SPi, for which the possibility of interference was judged to be high, and the number N1 of the plurality of rough checkpoints RCP, and computes the processing time S by multiplying such a value by the unit processing time PS.

In this instance, the value (N1+N2) obtained by adding the number N2 of plural checkpoints CP determined by the processing time computing unit 132 and the number N1 of rough checkpoints RCP does not coincide with the specified checkpoints CCP, ACP on which posture calculation and interference detection were actually carried out by the posture interference detecting unit 112. However, although the number N1 of plural rough checkpoints RCP and the number of specified checkpoints CCP are the same, while only the number N2 of plural checkpoints CP and the number of specified checkpoints ACP differ, both of these numbers are similar. Therefore, the computed processing time S is a value that approximates the processing time actually required to perform posture calculation and interference detection by the posture interference detection unit 112.

Below, it will be explained how the number N2 of the plural checkpoints CP and the number of specified checkpoints ACP approximate one another. Because the sampling points SP are set to a long time period (2 seconds) of the sampling time period Tc, the number of the time regions B specified based on the sampling points Spi for which the possibility for interference is high is comparatively small. In contrast thereto, since the specified checkpoints CCP are set to a short time (0.2 seconds) of the rough time period Tb, which is 1/10 of the sampling time period Tc, the number of time regions A specified based on the specified checkpoints CCPi for which the possibility for interference is high is larger than the number of specified time regions B. Therefore, the difference between the number of specified checkpoints ACPs inside of the specified plurality of time regions A, and the number N2 of checkpoints CPs inside of the specified one or plurality of time regions B lies within an allowable range. The number of individual checkpoints CP inside of one time region B is 10000, and the number of individual checkpoints CP (specified checkpoints ACP) inside of one time region A is 400.

The present invention is not limited to the embodiments described above, and various modifications may be adopted therein without departing from the essential scope of the present invention.

What is claimed is:

1. A processing time prediction method for predicting a processing time for determining postures of a first robot and a second robot, and detecting presence or absence of posture interference between the first robot and the second robot, at a plurality of specified checkpoints specified from among a plurality of checkpoints defined by segmenting a same operation time period in which operations of the first robot and the second robot are carried out into each of respective predetermined time intervals, the method comprising:
a sampling point setting step of setting a plurality of sampling points defined by segmenting the operation time period into respective sampling time intervals, which are longer than the predetermined time intervals;
a first calculation and measurement step of calculating a posture assumed by the first robot and a posture assumed by the second robot for each of the plurality of sampling points, and measuring and integrating a posture calculation time required for posture calculations;
a second calculation and measurement step of calculating the posture assumed by the first robot and the posture assumed by the second robot for each of the sampling points, detecting the presence or absence of interference based on the posture assumed by the first robot and the posture assumed by the second robot, and measuring and integrating a posture calculation and interference detection time required for the posture calculation and the interference detection;
an interference detection time computation step of computing an interference detection time of the interference detections required at the plurality of sampling points, from a difference between the posture calculation and interference detection time and the posture calculation time; and
a unit processing time computation step of computing a unit time by dividing the interference detection time by a number of the plurality of sampling points, and establishing the unit time as a unit processing time required for the posture calculation and the interference detection at one of the checkpoints.

2. The processing time prediction method according to claim 1, wherein the sampling time interval is an integral multiple of the predetermined time interval.
